(19) United States
(12) Patent Application Publication
(10) Pub. No.: US 2016/0295514 A1
(43) Pub. Date: Oct. 6, 2016

(54) INFORMATION TERMINAL, MOVEMENT ESTIMATION METHOD, AND STORAGE MEDIUM

(71) Applicant: NEC CORPORATION, Tokyo (JP)

(72) Inventors: Yuki CHIBA, Tokyo (JP); Yoji MIYAZAKI, Tokyo (JP)

(21) Appl. No.: 14/777,577

(22) PCT Filed: Jan. 17, 2014
(86) PCT No.: PCT/JP2014/050766

§ 371 Date: Sep. 16, 2015

(30) Foreign Application Priority Data
Mar. 22, 2013 (JP) 2013-060455

(51) Int. Cl. H04W 52/02; H04W 4/02; H04L 29/12; H04W 40/00

(52) U.S. Cl. CPC H04W 52/0254; H04W 40/005; H04W 4/027; H04L 61/6081; H04W 84/12

(57) ABSTRACT

An information terminal includes the following: an extraction unit that extracts, as change frequency information, at least one of the change frequency of index data and the change frequency of the movement state of a user, which are indicated by acquired index data; a setting unit that, based on the extracted change frequency information, sets a rule for controlling the sleep state of an estimation unit that estimates the movement state of the user; and a control unit that, based on the set rule, controls the sleep state of the estimation unit.

### CROSS-REFERENCE TO RELATED APPLICATIONS

This is a national stage of International Application No. PCT/JP2014/050766 filed Jan. 17, 2014, claiming priority based on Japanese Patent Application No. 2013-060455 filed Mar. 22, 2013, the entire contents of which are incorporated herein by reference.

### TECHNICAL FIELD

The present invention relates to an information terminal, a movement estimation method, and a program that estimate movements, states, and the like of a user or a thing.

### BACKGROUND ART

There is a system that, by acquiring position information and acceleration of a terminal via sensors or the like, estimates a movement state of the user who possesses the terminal or the movement state of a target object or the like to which the terminal is attached. The processing for estimating the movement state of a target object generally requires a large amount of calculation, so that the electric power consumption thereof is large. In such a system, in order to reduce its electric power consumption, it is preferable to cause a sensor or a sensor data processing to intermittently operate according to situations. However, if the sensor or the like is simply caused to be intermittently operated, the accuracy in estimating the movement state of a person or a thing that is targeted will decrease. Therefore, the timing of causing the sensor or the like to intermittently operate becomes crucial.

PTL 1 disclosed below teaches a technique in which a specified area indicating a place where a user stays for a long time (for example, the user's work place, the user's domicile, or the like) is set beforehand and in which when the user stays in the communication area controlled by a base station that contains the specified area, the number of start-ups of a GPS (Global Positioning System) sensor built in the user terminal is restrained to reduce the electric power consumption of the user terminal. Furthermore, PTL 2 disclosed below discloses a technique in which an acceleration of the target object and vibration that acts on the target object are acquired from an acceleration sensor of a control apparatus and, based on changes in the acquired acceleration and the acquired vibration, the cycle on which to cause a GPS receiver of the control apparatus to operate is changed so as to reduce the electric power consumption of the control apparatus.

### CITATION LIST

### Patent Literature

PTL 1: Japanese Laid-open Patent Publication No. 2011-097278
PTL 2: Japanese Laid-open Patent Publication No. 2011-145174

### SUMMARY OF INVENTION

### Technical Problem

The place where the user stays for a long time may change according to the movement of the user or the situation. However, as for the technique disclosed in PTL 1, the number of start-ups of the GPS is controlled within the specified area determined beforehand but the number of start-ups of the GPS is not controlled outside the specified area. So this allows more reducing of the electric power consumption. Furthermore, the technique disclosed in PTL 2 shortens the execution cycle of the processing of acquiring the position information about a target object in the vicinity of a destination to which the target object is transferred to accurately acquire position information about the target object. On the other hand, in places other than destinations, the technique disclosed in PTL 2 lengthens the execution cycle of the processing of acquiring position information about the target object to reduce the electric power consumption. Therefore, in the technique disclosed in PTL 2, in most areas other than the vicinity of the destination, the accuracy in recognizing the movement state of a target decreases.

The present invention has been accomplished in view of such circumstances, and provides a technique that estimates the movement state of a target with high accuracy while restraining the electric power consumption.

### Solution to Problem

Individual aspects of the present invention respectively adopt the following configurations in order to solve the foregoing problems.

A first aspect relates to an information terminal. The information terminal according to the first aspect includes an extraction unit that extracts as change frequency information at least one of change frequency of index data acquired or the change frequency of a movement state of a user which are indicated by the index data, a setting unit that sets a rule for controlling a sleep state of an estimation unit that estimates the movement state of the user, based on the extracted change frequency information, and a control unit that controls the sleep state of the estimation unit based on the set rule.

A second aspect relates to a movement estimation method that is executed by an information terminal (computer). The movement estimation method according to the second aspect includes a computer extracting as change frequency information at least one of change frequency of index data acquired or the change frequency of a movement state of a user which are indicated by the index data, setting a rule for controlling a sleep state of an estimation unit that estimates the movement state of the user, based on the extracted change frequency information, and controlling the sleep state of the estimation unit based on the set rule.

Note that other aspects of the present invention may be a program that causes an information terminal to realize the configuration of each of the foregoing aspects, or may also be a recording medium in which such a program has been recorded and which is readable by a computer. This recording medium includes a non-temporary tangible medium.

### Advantageous Effects of Invention

According to the foregoing aspects, it is possible to estimate the movement state of a target with high accuracy while restraining the electric power consumption.

### BRIEF DESCRIPTION OF DRAWINGS

The foregoing object and other objects, features and advantages will become apparent with reference to preferred exemplary embodiments described below and the following drawings that accompany the preferred exemplary embodiments.

FIG. 1 is a diagram conceptually illustrating a hardware configuration example of an information terminal in a first exemplary embodiment.

FIG. 2 is a diagram conceptually illustrating a processing construction example of the information terminal in the first exemplary embodiment.

FIG. 3A and FIG. 3B are diagrams illustrating examples of a control rule set based on change frequency information.

FIG. 4 is a flowchart illustrating a flow in which the information terminal in the first exemplary embodiment sets a control rule for an estimation unit.

FIG. 5 is a flowchart illustrating a flow in which the information terminal in the first exemplary embodiment controls a sleep state of the estimation unit.

FIG. 6A and FIG. 6B are diagrams illustrating another example of a control rule set based on change frequency information.

FIG. 7 is a diagram conceptually illustrating a processing configuration example of an information terminal in a second exemplary embodiment.

FIG. 8 is a flowchart illustrating a flow of processing by the information terminal in the second exemplary embodiment.

FIG. 9 is a diagram illustrating examples of transition of degrees of sleep.

FIG. 10 is a diagram conceptually illustrating a processing configuration example of an information terminal in a third exemplary embodiment.

FIG. 11 is a diagram illustrating an example of correspondence relations between change frequency information and specific index data stored in a storage unit.

FIG. 12 is a flowchart illustrating a flow of processing by the information terminal in the third exemplary embodiment.

FIG. 13 is a diagram conceptually illustrating a processing configuration example of a movement estimation system in a fourth exemplary embodiment.

FIG. 14 is a flowchart illustrating a flow of processing by an information terminal in the fourth exemplary embodiment.

FIG. 15 is a diagram conceptually illustrating a processing configuration example of an information terminal in a fifth exemplary embodiment.

FIG. 16 is a flowchart illustrating a flow in which the information terminal in the fifth exemplary embodiment corrects an estimation result.

FIG. 17 is a diagram conceptually illustrating a processing configuration example of an information terminal in a sixth exemplary embodiment.

FIG. 18 is a diagram illustrating an example of information that a movement tendency storage unit stores.

FIG. 19 is a flowchart illustrating a flow of processing by the information terminal in the sixth exemplary embodiment.

### DESCRIPTION OF EMBODIMENTS

Hereinafter, exemplary embodiments of the present invention will be described. Note that the exemplary embodiments presented below are each exemplification, and the present invention is not limited to the configurations of the exemplary embodiments below. Furthermore, like constituent elements are assigned with like signs in all the drawings used in conjunction with the following exemplary embodiments, and descriptions thereof will be omitted as appropriate.

### First Exemplary Embodiment

### Apparatus Configuration

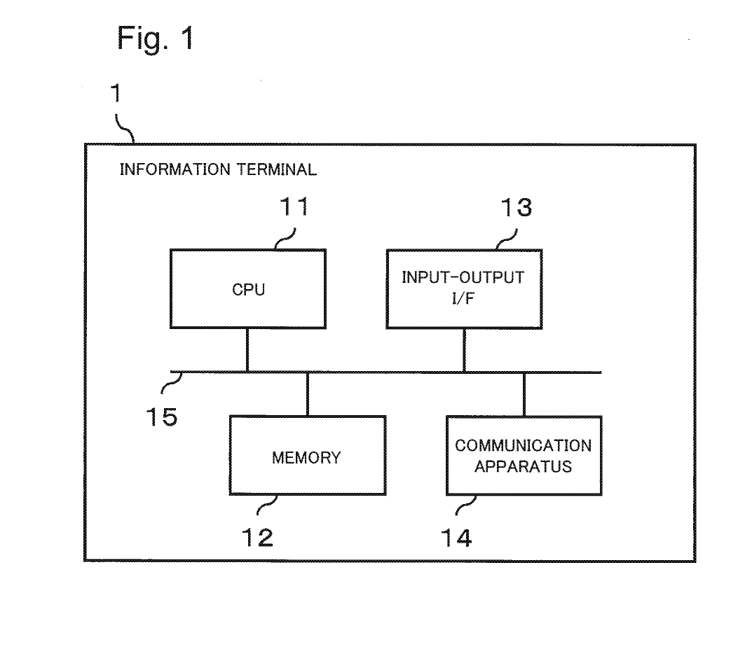

FIG. 1 is a diagram conceptually illustrating a hardware configuration example of an information terminal 1 in a first exemplary embodiment. As illustrated in FIG. 1, the information terminal 1 has a CPU (Central Processing Unit) 11, a memory 12, an input-output interface (I/F) 13, a communication apparatus 14, and the like. These units are connected to, for example, a bus 15. The memory 12 is a RAM (Random Access Memory), a ROM (Read Only Memory), a hard disk, a portable type storage medium, and the like. The input-output I/F 13 is connected to input-output apparatuses such as a GPS apparatus, various sensors including an atmospheric pressure sensor and an acceleration sensor, and the like. The communication apparatus 14 communicates, wirelessly or via a cable, with other apparatuses located outside.

Note that as for FIG. 1, the present exemplary embodiment does not restrict the hardware configuration of the information terminal 1. For example, the information terminal 1 may be a portable terminal, such as a so-called cellular phone or a PDA (Personal Digital Assistant), and may have a display apparatus, such as a display, an apparatus for inputting or outputting sound, and the like.

[Processing Configuration]

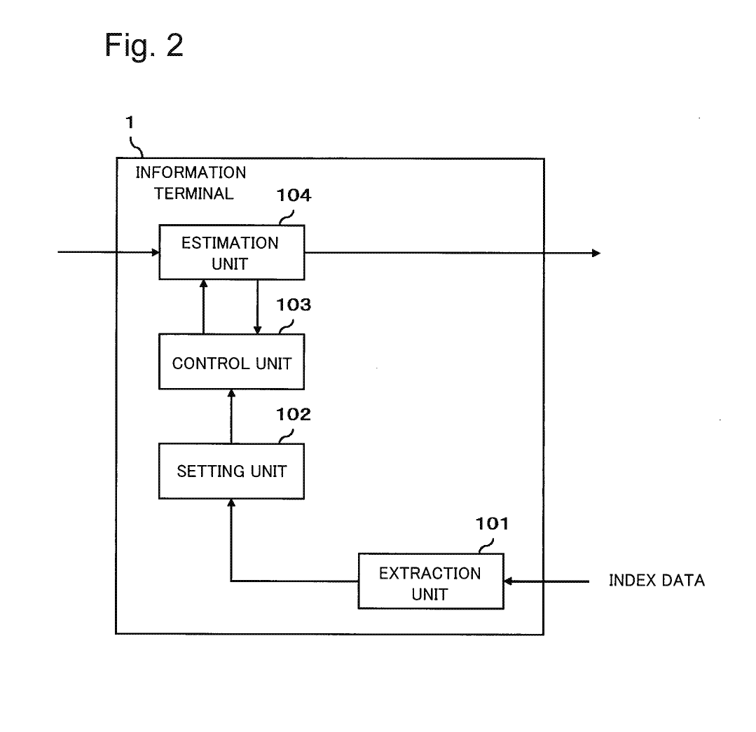

FIG. 2 is a diagram conceptually illustrating a processing configuration example of the information terminal 1 in the first exemplary embodiment. Furthermore, FIG. 2 illustrates only a configuration related to a movement estimation method that is executed by the information terminal 1 in the present exemplary embodiment. Therefore, the information terminal 1 has multiple processing units other than the processing units depicted.

The information terminal 1 has an extraction unit 101, a setting unit 102, a control unit 103, an estimation unit 104, and the like. These processing units are realized by, for example, the CPU 11 executing programs stored in the memory 12. Furthermore, the programs may be installed, for example, from a portable type recording medium, such as a CD (Compact Disc) or a memory card, or other apparatuses via the input-output I/F 13 or the communication apparatus 14, and may be stored in the memory 12.

The estimation unit 104, based on information obtained from acceleration sensors or a GPS reception apparatus, or the like, executes a movement estimation processing of estimating a movement state of a user. Note that the “movement state” refers to movements related to the moving of a user among the various movements that the user can take. As examples of the movement states of a user, there can be cited a “stop” indicating a state in which the user is stationary at a location, a “walk/run/stairs” indicating any one of a state in which the user is walking, a state in which the user is running, or a state in which the user is ascending or descending on stairs, a “motor vehicle” indicating a state in which the user is riding in a motor vehicle, an “electric train” indicating a state in which the user is riding on an electric train, and the like. However, there are mere examples, and the movement states of users are not limited by theses. For example, the movement state of the “walk/run/stairs” may be individually separated into “walk”, “run”, and “stairs”. Incidentally, the movement estimation processing can be realized by using known technologies. Furthermore, the estimation unit 104 can be switched to a sleep state or an operating state through control of the control unit 103.

The extraction unit 101 acquires index data via the memory 12, the input-output I/F 13, and the communication apparatus 14. Then, the extraction unit 101 extracts as change frequency information at least one of a frequency of change of the index data and a frequency of change of the movement state of the user which are indicated by the index data acquired. Then, the extraction unit 101 sends the change frequency information extracted from the index data to the setting unit 102. The extraction unit 101 will be described in detail below.

Note that the “index” is information that can indicate the change frequency of the user's movement state and the “index data” is data that includes this index. Concretely, the index data is, for example, the base station ID of a communication base station, the SSID (Service Set Identifier) of a Wi-Fi (Wireless Fidelity) access point, the atmospheric pressure acquired via an atmospheric pressure sensor or the like, schedule information about the user of the information terminal 1, and the like.

The extraction unit 101 extracts the change frequency of the index data from the acquired index data. Taking the example of the index data described above, the extraction unit 101 is able to extract the change frequency of the index data from the base station ID of the communication base station, the SSID of the Wi-Fi access point, and the atmospheric pressure. In this case, the extraction unit 101 is able to extract, for example, the presence or absence of change of the base station ID within a predetermined time, the number of times of change of the base station ID within a predetermined time, and the like, as the change frequency of the index data. Furthermore, the extraction unit 101 is able to extract, for example, differences between the SSID lists of Wi-Fi access points acquired at every predetermined time, and the like, as the change frequency of the index data. Furthermore, the extraction unit 101 is able to extract, for example, the change amount of the atmospheric pressure measured at every predetermined time, and the like, as the change frequency of the index data.

Still further, from the change frequency of the index data, the change frequency of the user's movement state can be estimated. For example, when the atmospheric pressure, the SSID of the Wi-Fi access point, and the base station ID acquired by the extraction unit 101 have frequently changed, that is, the change frequency of the index data is great, the possibility of the user being moving is high. Then, when the user is moving, there is a possibility of the user making various movements, such as using various moving means. Therefore, when the change frequency of the index data is great, it can be estimated that the time during which a constant movement state is maintained is short and that the user's movement state is likely to change (the change frequency is great). Conversely, when the base station ID, the SSID of the Wi-Fi access point, and the atmospheric pressure have not changed much, that is, the change frequency of the index data is small, the possibility of the user being staying in a predetermined area is high. Then, when the user is staying, the time during which a constant movement state (in particular, the “stop” or the like) is maintained tends to be relatively longer than when the user is moving. Therefore, when the change frequency of the index data is small, it can be estimated that the user's movement state is unlikely to change (the change frequency is small).

Furthermore, the extraction unit 101 can sometimes extract the change frequency of the user's movement state from the acquired index data. Taking the example of the index data stated above, the extraction unit 101 can extract the change frequency of the user's movement state from the schedule information. In this case, for example, based on the present time and the time information included in the schedule information, the extraction unit 101 specifies a keyword that represents the user's movement plan at the time, such as “conference”, “moving”, and “being in”. Note that from the specified keyword, the change frequency of the user's movement state can be estimated. For example, from a keyword that allows inference that the time during which the user maintains a constant movement state is long, such as the “conference” or the “being in”, it can be estimated that the change frequency of the user's movement state is small. Furthermore, from a keyword that allows inference that the time during which the user maintains a constant movement state is short, such as “moving”, it can be estimated that the change frequency of the user's movement state is great. Then, if a list in which such keywords and the change frequencies of the user's movement state are associated with each other, or the like is prepared in a storage area, such as the memory 12 of the information terminal 1 or a storage of an external apparatus, the extraction unit 101 can extract from that list the change frequency of the user's movement state by using a specified keyword.

The setting unit 102, based on the change frequency information extracted by the extraction unit 101, sets a rule for controlling the sleep state of the estimation unit 104 (control rule). The control rule includes at least a condition for causing the estimation unit 104 to sleep and the sleep time that corresponds to that condition. Note that when the change frequency indicated by the change frequency information is great, that is, the change frequency of the user's movement state is great, it can be estimated, as stated above, that the time, during which the user maintains a constant movement state, is short. Therefore, the setting unit 102 sets in the information terminal 1 a control rule which controls the sleep time to be shorter than that of when the change frequency indicated by the change frequency information is small. On the other hand, when the change frequency indicated by the change frequency information is small, that is, the change frequency of the user's movement state is small, it can be estimated, as stated above, that the time during which the user maintains a constant movement state is long. Therefore, the setting unit 102 sets in the information terminal 1 a control rule which controls the sleep time to be longer than that of when the change frequency indicated by the change frequency information indicates is great. This control rule is realized, for example, as a plurality of tables that are different in set values of the sleep time and the like. In this case, the setting unit 102 selects one of the tables according to the change frequency information extracted by the extraction unit 101, and causes the control unit 103 to refer to the selected table. Furthermore, the control rule may be realized as a function which generates a longer sleep time the smaller the change frequency indicated by the change frequency information. In this case, the setting unit 102 may cause the control unit 103 to refer to a control rule generated by substituting in the function the quantitative change frequency information extracted by the extraction unit 101. Thus, the setting of a control rule by the setting unit 102 means that the setting unit 102 causes another processing unit (the control unit 103 or the like) to operate based on the control rule.

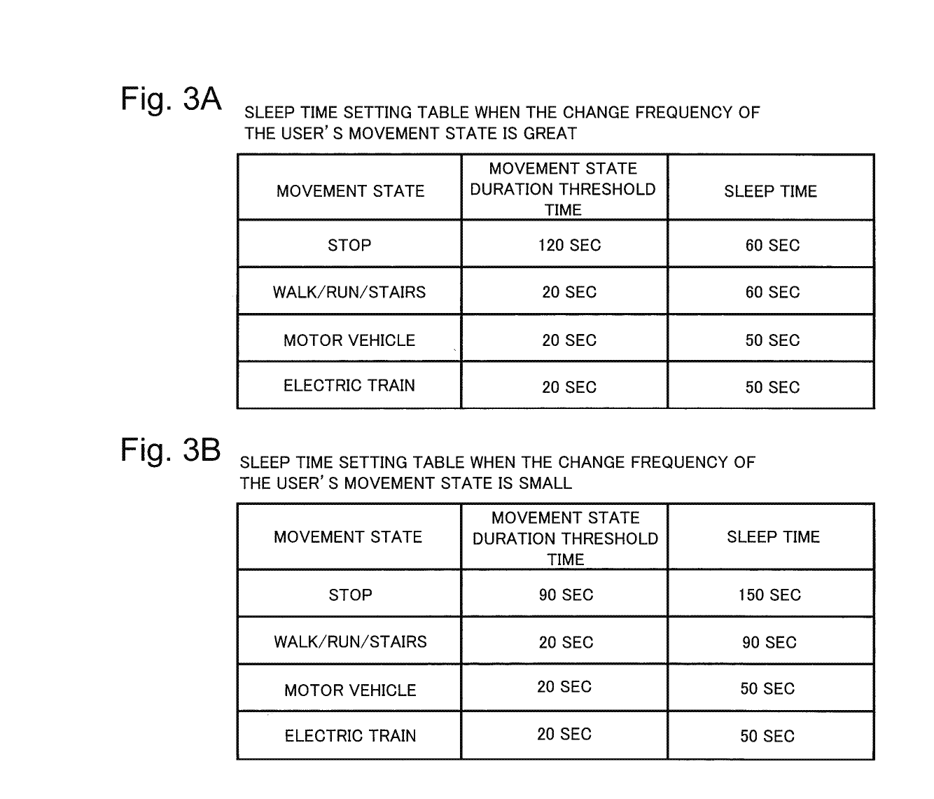

An example of a control rule set based on the change frequency information is illustrated in FIG. 3A and FIG. 3B. Furthermore, in FIG. 3A and FIG. 3B, two different tables that define how to control the sleep state (sleep time setting tables) are exemplified. FIG. 3A is a sleep time setting table that is applied when the change frequency indicated by the change frequency information indicates is great, that is, the change frequency of the user's movement state is great. Furthermore, FIG. 3B is a sleep time setting table that is applied when the change frequency indicated by the change frequency information indicates is small, that is, the change frequency of the user's movement state is small. Each record in the sleep time setting tables means that when a movement state such as “stop” indicated in the column of “MOVEMENT STATE” is estimated continuously for the time indicated in the column of “MOVEMENT STATE CONTINUATION THRESHOLD TIME”, the estimation unit 104 is caused to sleep for the time indicated in “SLEEP TIME”. For example, the uppermost record in the sleep time setting table of FIG. 3A means that when the user's movement state is estimated “stop” by the estimation unit 104 continuously for 120 seconds, the estimation unit 104 is caused to sleep for 60 seconds. Furthermore, as for the movement state continuation threshold time and the sleep time set in the sleep time setting tables, values empirically known from sample data or the like are set. Furthermore, in the sleep time setting table of FIG. 3A, the movement state continuation threshold time is set longer and the sleep time is set shorter than in the sleep time setting table of FIG. 3B. This is because in a situation where the table of FIG. 3A is selected, that is, when the change frequency of the user's movement state is great, it becomes relatively difficult to judge that a movement state will further continue unless monitoring is performed for an increased duration time of that movement state, and the further duration time of that movement state will become relatively short, as compared with the situation where the table of FIG. 3B is selected.

Sleep time setting tables as in FIG. 3A and FIG. 3B are set, for example, in the setting unit 102, beforehand. Then, the setting unit 102 determines which one of the sleep time setting tables is to be used, based on whether or not the change frequency information extracted by the extraction unit 101 is greater than or equal to a predetermined threshold value. For example, when the change frequency information extracted by the extraction unit 101 is greater than or equal to the predetermined threshold value, the setting unit 102 judges that “the change frequency of the user's movement state is great”, and determines that the sleep time setting table of FIG. 3A is to be used as a control rule. On the other hand, when the change frequency information extracted by the extraction unit 101 is less than the predetermined threshold value, the setting unit 102 judges that “the change frequency of the user's movement state is small”, and determines that the sleep time setting table of FIG. 3B is to be used as a control rule. In this manner, the control rule that defines how the estimation unit 104 is to be caused to sleep is set in the information terminal 1. Furthermore, the control rule, such as these sleep time setting tables, may be stored in a storage unit (not depicted), and the setting unit 102 may read out one of the sleep time setting tables from the storage unit, based on whether or not the change frequency information extracted by the extraction unit 101 is greater than or equal to the predetermined threshold value. Besides, the storage unit storing the control rule, such as these sleep time setting tables, may be contained in the information terminal 1, or may also be contained in another apparatus located outside the information terminal 1.

The control unit 103 controls the sleep state of the estimation unit 104 based on the control rule set by the setting unit 102. Note that “controlling the sleep state of the estimation unit 104” refers to switching between the sleep state in which the estimation unit 104 is unable to execute the movement estimation processing (is in sleep) and an operating state in which the estimation unit 104 is able to execute the movement estimation processing (is not in sleep). Incidentally, the present exemplary embodiment, operations of the control unit 103 will be described with reference to an example the case where a control rule as illustrated in FIG. 3A and FIG. 3B is used. In this case, the control unit 103 determines whether to cause the estimation unit 104 to sleep based on the duration time of the user's movement state estimated by the estimation unit 104. Concretely, the control unit 103 receives the user's movement state estimated by the estimation unit 104, and determines whether or not the duration time of the estimated movement state of the user satisfies a condition set in the control rule. Then, in the case where the condition set in the control rule is satisfied, the control unit 103 causes the estimation unit 104 to sleep until a sleep time associated with that condition elapses. Furthermore, if the estimation unit 104 is executing the movement estimation processing at predetermined intervals (for example, every 10 seconds or the like), the control unit 103 can control the sleep state of the estimation unit 104, using as a condition the number of times of continuation of the user's movement state estimated by the estimation unit 104. In this case, for example, when the user's movement state estimated by the estimation unit 104 satisfies a predetermined condition that the user's movement state estimated has been the “stop” five consecutive times, the control unit 103 causes the estimation unit 104 to sleep until a sleep time associated with that condition elapses.

### Operation Examples

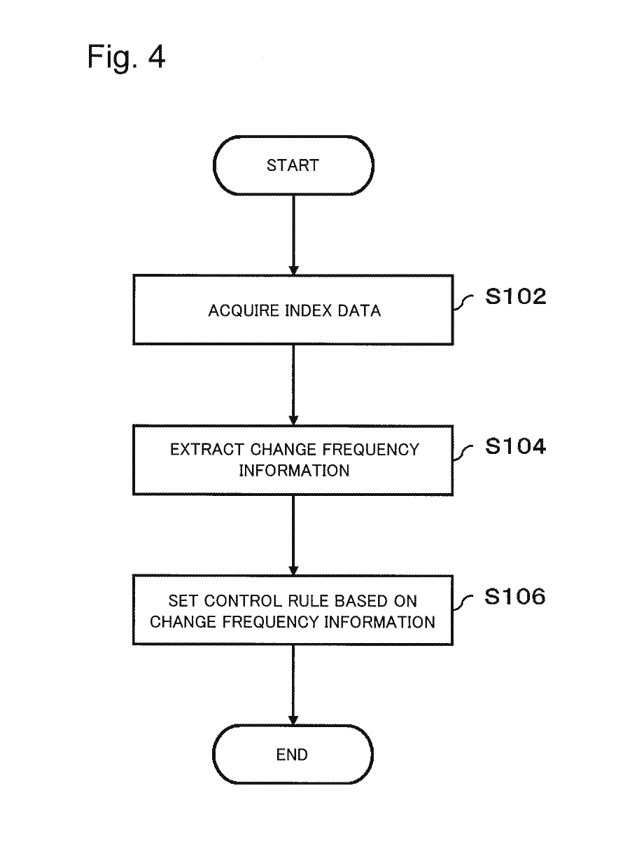

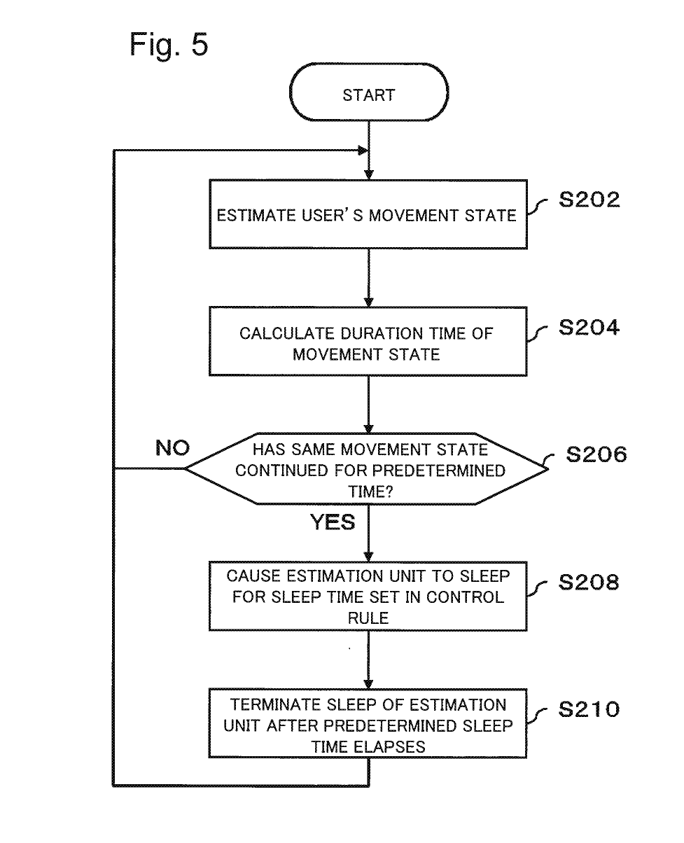

Hereinafter, a flow of processing by the information terminal 1 in the first exemplary embodiment will be described using FIG. 4 and FIG. 5. FIG. 4 is a flowchart illustrating a flow in which the information terminal 1 in the first exemplary embodiment sets a control rule for the estimation unit 104. FIG. 5 is a flowchart illustrating a flow in which the information terminal 1 in the first exemplary embodiment controls the sleep state of the estimation unit 104.

First, using FIG. 4, the flow in which the information terminal 1 sets the control rule for the estimation unit 104 will be described. Note that in conjunction with the present exemplary embodiment, description is made using as an example the case where the information terminal 1 acquires the base station ID as index data.

First, the information terminal 1 acquires the base station ID as index data (S102). Then, the information terminal 1 extracts the change frequency of the base station ID acquired in S102, as change frequency information (S104). Then, based on the change frequency information extracted in S104, the information terminal 1 sets the control rule for the estimation unit 104 (S106). For example, the information terminal 1 acquires the present base station ID and checks whether a change in the base station ID is present or absent, at every predetermined time (for example, 10 minutes). Then, the information terminal 1 extracts the number of times of change of the base station ID within a predetermined time, and the like, as change frequency information. Then, when the change frequency information (the number of times of the base station ID within the predetermined time, and the like) is greater than or equal to a predetermined threshold value, the information terminal 1 judges that the change frequency indicated by the change frequency information indicates is great, and sets such a control rule which controls the sleep time to be shorter than that of when the change frequency indicated by the change frequency information indicates is small. On the other hand, when the change frequency information is less than the predetermined threshold value, the information terminal 1 judges that the change frequency indicated by the change frequency information indicates is small, and sets such a control rule which controls the sleep time to be longer than that of when the change frequency indicated by the change frequency information indicates is great.

Next, using FIG. 5, a flow in which the information terminal 1 controls the sleep state of the estimation unit 104 will be described.

First, the information terminal 1 estimates the user's movement state by the estimation unit 104 (S202). The estimation unit 104, based on, for example, the GPS information or information acquired from an acceleration sensor or the like, calculates the moving speed of the user or the like and estimates the present movement state of the user. Then, the information terminal 1 calculates the duration time of the movement state estimated in S202 (S204). The information terminal 1 can calculate the duration time of the movement state, for example, by counting the time from when a certain movement state is estimated to when a different movement state is estimated. Then, the information terminal 1 determines whether or not the movement state estimated in S202 has been continuing for a predetermined time or longer (S206). Incidentally, this predetermined time is determined based on the control rule set in S106. For example, when the sleep time setting table of FIG. 3A has been set in S106 and it has been estimated in S202 that the user's movement state is the “stop”, the predetermined time used in S206 is “120 seconds”. On another hand, when the sleep time setting table of FIG. 3B has been set in S106 and it has been estimated in S202 that the user's movement state is the “stop”, the predetermined time used in S206 is “90 seconds”. When the movement state estimated in S202 has not been continuing for the predetermined time or longer (S206: NO), the information terminal 1 continues the movement estimation processing (S202). On another hand, when the movement state estimated in S202 has been continuing for the predetermined time or longer (S206: YES), the information terminal 1 causes the estimation unit 104 to sleep for a sleep time that corresponds to the movement state estimated in S202, based on the set control rule (S208). For example, let it assumed that in S106, the sleep setting table illustrated in FIG. 3A has been set. If during this state, the user's movement state is estimated to have been “stop” continuously for 120 seconds by the estimation unit 104, the information terminal 1 causes the estimation unit 104 to sleep for 60 seconds. Furthermore, if the user's movement state is estimated to have been “walk/run/stairs” continuously for 20 seconds by the estimation unit 104, the information terminal 1 causes the estimation unit 104 to sleep for 60 seconds. Furthermore, if the user's movement state is estimated to have been “motor vehicle” continuously for 20 seconds by the estimation unit 104, the information terminal 1 causes the estimation unit 104 to sleep for 50 seconds. Furthermore, if the user's movement state is estimated to have been “electric train” continuously for 20 seconds by the estimation unit 104, the information terminal 1 causes the estimation unit 104 to sleep for 50 seconds. Then, after a predetermined sleep time elapses, the information terminal 1 terminates the sleep state of the estimation unit 104 (S210), and causes the estimation unit 104 to re-start the movement estimation processing (S202).

The above is a flow of processing by the information terminal 1 in the first exemplary embodiment. Incidentally, the processing illustrated in FIG. 4 and FIG. 5 is each executed independently. Then, the control rule used in S206 is dynamically changed according to the change frequency information acquired in S104.

### Operation and Effects of First Exemplary Embodiment

As in the above, in the present exemplary embodiment, from the change frequency information extracted from the index data, a control rule for controlling the sleep state of the estimation unit 104 is set in the information terminal 1. Then, based on the set control rule, the sleep state of the estimation unit 104 is controlled. Due to this, according to the present exemplary embodiment, it is possible to control the sleep state of the estimation unit 104 in accordance with the change frequency of the user's movement state. Concretely, when the change frequency indicated by the change frequency information extracted from the index data is great, in other words, when the change frequency of the user's movement state is great, such a control rule which controls the sleep time to be shorter than that of when the change frequency indicated by the change frequency information is small is set in the information terminal 1, and the sleep state of the estimation unit 104 is controlled according to that control rule. On the other hand, when the change frequency indicated by the change frequency information extracted from the index data is small, in other words, when the change frequency of the user's movement state is small, such a control rule which controls the sleep time to be longer than that of when the change frequency indicated by the change frequency information is great is set, and the sleep state of the estimation unit 104 is controlled according to that control rule. By doing so, the information terminal 1, in a situation where the user's movement state is apt to change, can increase the execution frequency of the movement estimation processing by the estimation unit 104 and can improve the estimation accuracy for the movement state of the target. Furthermore, by doing so, the information terminal 1, in a situation where the user's movement state is inapt to change, can restrain useless movement estimation processing from being executed by the estimation unit 104, and can reduce the electric power consumed in the movement estimation processing.

The change frequency of the user's movement state described above can be determined if using an estimation result of the movement estimation processing without using the change frequency information extracted from the index data. However, from a general consideration, the movement estimation processing requires a greater calculation quantity than the processing of extracting the change frequency information from the index data. In this respect, it can be said that the information terminal 1 according to the present invention can reduce the electric power consumption more efficiently than when the estimation result of the movement estimation processing is used.

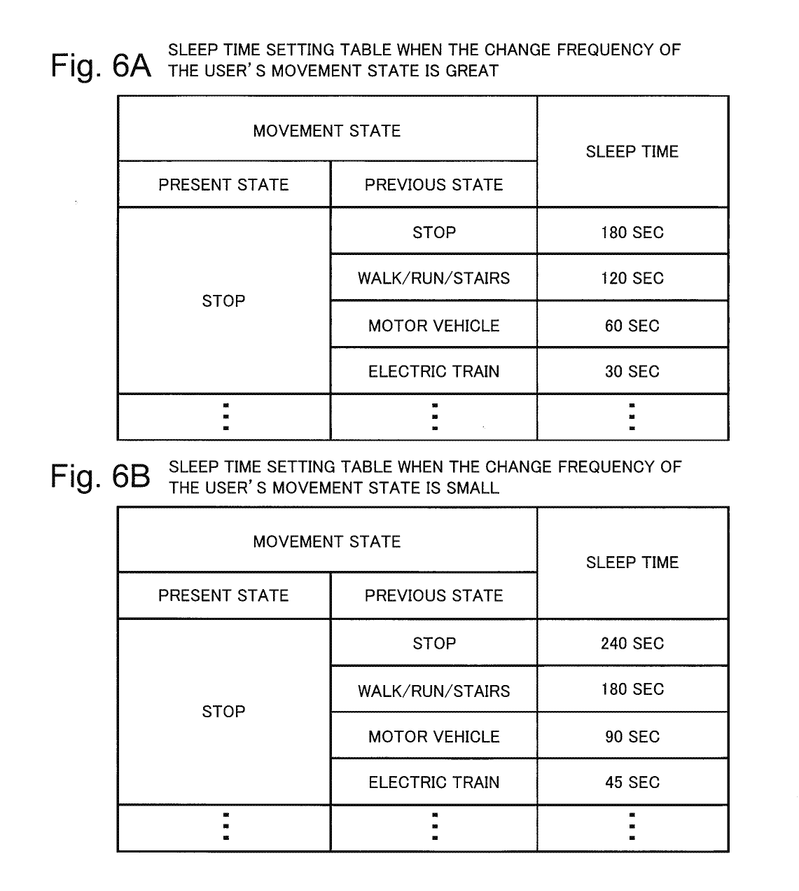

Furthermore, the control rule set in the setting unit 102 is not limited to FIG. 3A and FIG. 3B. For example, the setting unit 102 may set such a control rule which controls the sleep state based on a change pattern of the movement state estimated by the estimation unit 104. FIG. 6A and FIG. 6B are diagrams illustrating another example of a control rule set based on the change frequency information. When the control rule illustrated in FIG. 6A and FIG. 6B is used, the information terminal 1 controls the sleep state of the estimation unit 104 according to the change pattern of the user's movement state estimated by the estimation unit 104. Concretely, when the user's movement state estimated by the estimation unit 104 changes from a movement state indicated under “PREVIOUS MOVEMENT STATE” to a movement state indicated under “PRESENT MOVEMENT STATE”, the information terminal 1 causes the estimation unit 104 to sleep for a time indicated under “SLEEP TIME” that is associated with “PREVIOUS MOVEMENT STATE” and “PRESENT MOVEMENT STATE” Incidentally, although FIG. 6A and FIG. 6B illustrate no change patterns other than the change patterns of the movement state related to “stop”, sleep times are set according to the change patterns of various movement states similarly for “walk/run/stairs”, “motor vehicle”, “electric train”, and the like. Note that what the change pattern of the movement state means can change depending on the change frequency of the user's movement state. As an example, a case where the user's movement state estimated by the estimation unit 104 has changed from “walk” to “stop” will be considered. When the change frequency of the user's movement state is great, it can be judged that this change pattern is that the user has temporarily stopped, such as when the user has stopped at a red light during the user's moving outdoors, and that the “stop” state will not continue for so long. On the other hand, when the change frequency of the user's movement state is small, it can be judged that this change pattern is that the user has stopped on a long-term basis, such as when the user has sit on the user's own seat at the user's work place, and that the “stop” state will further continue for a long time. Therefore, the foregoing effects can be achieved in this manner as well.

### Second Exemplary Embodiment

An information terminal 1 in the present exemplary embodiment converts change frequency information pieces extracted from a plurality of kinds of index data each having different indexes into unified change frequency information (degree of sleep) having a unified index, and sets a control rule based on this unified change frequency information. Hereinafter, the information terminal 1 in the second exemplary embodiment will be described, centering on contents different from those of the first exemplary embodiment. In the description below, substantially the same contents as those of the first exemplary embodiment will be omitted from the description as appropriate.

[Processing Configuration]

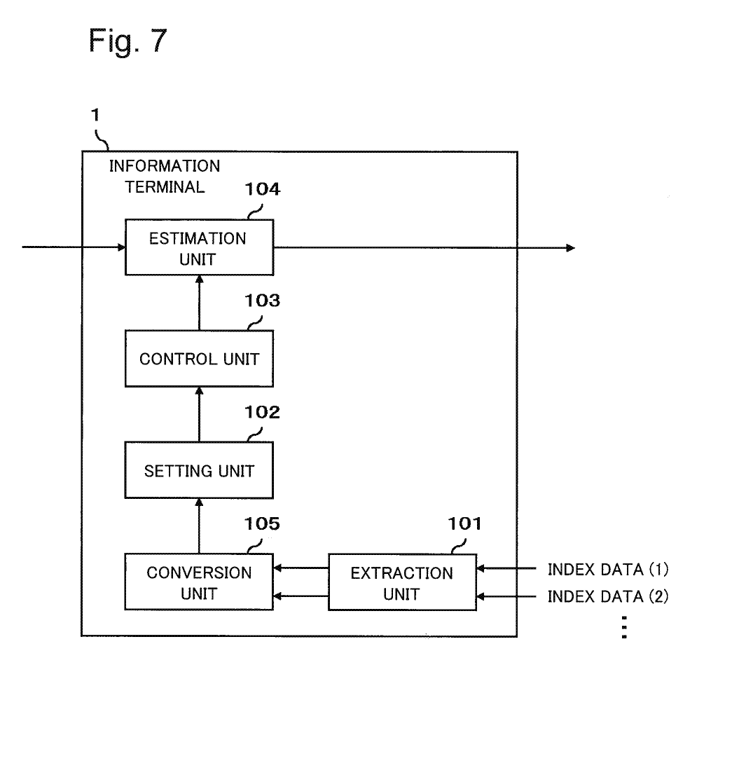

FIG. 7 is a diagram conceptually illustrating a processing configuration example of the information terminal 1 in the second exemplary embodiment. As illustrated in FIG. 7, the information terminal 1 in the present exemplary embodiment further has a conversion unit 105.

In the present exemplary embodiment, the extraction unit 101 acquires a plurality of kinds of index data each having different indexes. Then, the extraction unit 101 extracts change frequency information pieces from the various index data.

Then, the conversion unit 105 converts the individual change frequency information pieces extracted by the extraction unit 101 into degrees of sleep. Note that the degree of sleep is a unified index that makes it possible to be equally handled the change frequency information pieces extracted respectively from the plurality of kinds of index data each having different indexes. The conversion unit 105 converts the change frequency information pieces extracted respectively from the plurality of kinds of index data into degrees of sleep in the following manner. For example, when the base station ID has been acquired as an index data, the conversion unit 105 determines whether or not the presently acquired base station ID has changed from the previous acquired base station ID. When, as a result of the determination, the presently acquired base station ID has not changed from the previously acquired base station ID, the conversion unit 105 adds a predetermined value (for example, “1” or the like) to the degree of sleep. On the other hand, when the presently acquired base station ID has changed from the previously acquired base station ID, the conversion unit 105 resets the degree of sleep to 0. Incidentally, the conversion unit 105, not being limited to this, may subtract a predetermined value from the degree of sleep when the presently acquired base station ID has changed from the previously acquired base station ID. Furthermore, when the extraction unit 101 has acquired schedule information as index data, the conversion unit 105 converts keywords, such as “conference”, “being in” and “moving”, into degrees of sleep. Generally, if the keyword acquired from the schedule information is “conference” or “being in”, it can be judged that the change frequency information is small. Conversely, if the keyword acquired from the schedule information is “moving”, it can be judged that the change frequency information is great. Therefore, the conversion unit 105, for example, has in the storage unit or the like a prepared list that indicates association between degrees of sleep and various keywords acquired from the schedule information, and converts the schedule information into a degree of sleep by referring to this list.

In this manner, since the conversion unit 105 translates the individual change frequency information pieces extracted from index data each having different indexes, such as “base station ID” or “schedule information”, into an unified index that is “degree of sleep”, the setting unit 102 can equally handle individual change frequency information pieces. Then, the setting unit 102 sets a control rule based on the degrees of sleep converted from the change frequency information pieces of the various index data. In the present exemplary embodiment, the setting unit 102 sets a control rule that includes the start timing of sleep (sleep starting line) and the sleep time, based on the degrees of sleep. Concretely, the setting unit 102 judges a change frequency that has comprehensively factored in various index data, from the degrees of sleep. Then, the setting unit 102 sets the sleep starting line or the sleep time according to the change frequency that has comprehensively factored in various index data, in other words, the change frequency of the user's movement state. Incidentally, the sleep starting line is a so-called threshold value. When the degree of sleep exceeds this sleep starting line, the control unit 103 causes the estimation unit 104 to sleep. When the control unit 103 has caused the estimation unit 104 to sleep, the setting unit 102 resets the degree of sleep. Then, when the sleep state of the estimation unit 104 is terminated, the foregoing processing is started again.

Note that when the degree of sleep which increases and decreases due to the conversion unit 105, is arranged in a time series, the gradient of the degree of sleep can be calculated. The gradient of the degree of sleep indicates the change frequency of the user's movement state comprehensively indicated from the change frequency information pieces extracted from various index data. Hence, by checking the gradient of the degree of sleep, the setting unit 102 can determine the change frequency of the user's movement state. For example, if the degree of sleep has sharply risen, the setting unit 102 can determine that the change frequency of the user's movement state indicated by the change frequency information pieces about various index data is small. Then, when the degree of sleep has sharply risen, the setting unit 102 lowers the sleep starting line, or sets the sleep time long, or the like so as to lengthen the time during which the estimation unit 104 is in the sleep state. On the other hand, if the degree of sleep has gently risen or the degree of sleep has decreased, the setting unit 102 can determine that the change frequency of the user's movement state indicated by various index data is great. Then, when the degree of sleep has gently risen or fallen, the setting unit 102 raises the sleep starting line, sets the sleep time short, or the like so as to shorten the time during which the estimation unit 104 is in the sleep state. Note that the change amount of the sleep time and the sleep starting line adjusted by the setting unit 102 may be value determined beforehand or a value calculated according to the gradient of the degree of sleep. Incidentally, the gentleness or sharpness of the gradient of the degree of sleep can be determined based on whether or not the gradient of the degree of sleep is greater than or equal to a predetermined threshold value, for example.

Furthermore, the conversion unit 105 may add to the degree of sleep when the index data has changed, and may reset or subtract from the degree of sleep when the index data has not changed. In this case, if the degree of sleep has sharply risen, the setting unit 102 can judge that the change frequency of the user's movement state is great. Then, when the degree of sleep has sharply risen, the setting unit 102 raises the sleep starting line, or sets the sleep time short, or the like so as to shorten the time during which the estimation unit 104 is in the sleep state. On the other hand, if the degree of sleep has gently risen or lowered, the setting unit 102 can judge that the change frequency of the user's movement state is small. Then, when the degree of sleep has gently risen or lowered, the setting unit 102 lowers the sleep starting line, sets the sleep time long, or the like so as to lengthen the time during which the estimation unit 104 is in the sleep state.

Furthermore, the conversion unit 105 may convert, instead of the presence or absence of change in the index data, the change amount of the index data, such as the number of times of change of the base station ID within a predetermined time, into the degree of sleep. In this case, the conversion unit 105 may add to or subtract from the degree of sleep as mentioned above depending on whether or not the change amount of the index data is greater than or equal to a predetermined threshold value, or may directly substitute the change amount of the index data for the degree of sleep.

### Operation Examples

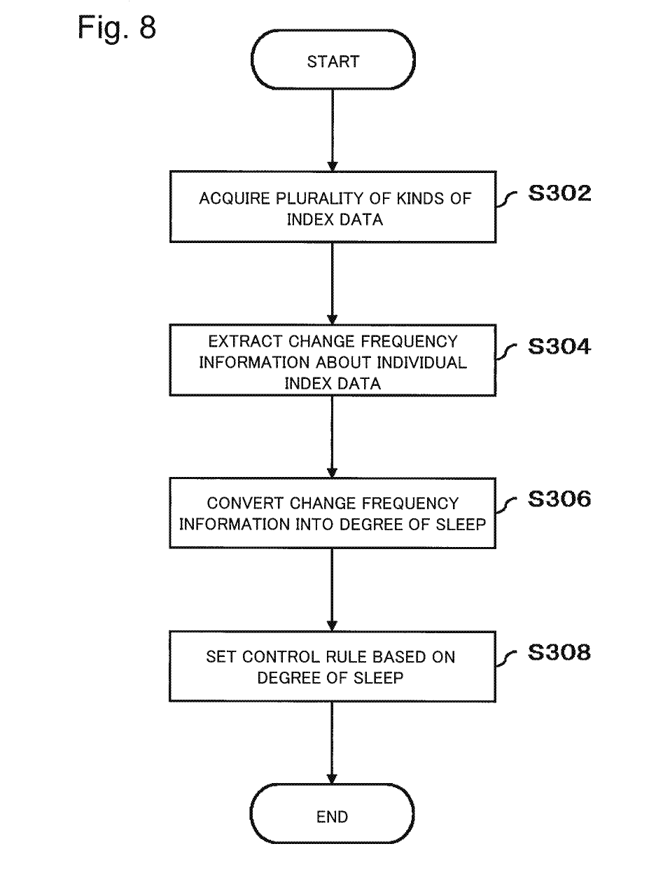

Hereinafter, a flow of processing by the information terminal 1 in the second exemplary embodiment will be described by using FIG. 8. FIG. 8 is a flowchart illustrating the flow of processing by the information terminal 1 in the second exemplary embodiment.

First, the information terminal 1 acquires a plurality of kinds of index data (S302). Then, the information terminal 1 extracts change frequency information pieces about the various index data acquired in S302 (S304). Then, the information terminal 1 converts each change frequency information piece extracted in S304 into a degree of sleep (S306). Then, based on the degrees of sleep converted in S306, the information terminal 1 sets a control rule for the estimation unit 104 (S308).

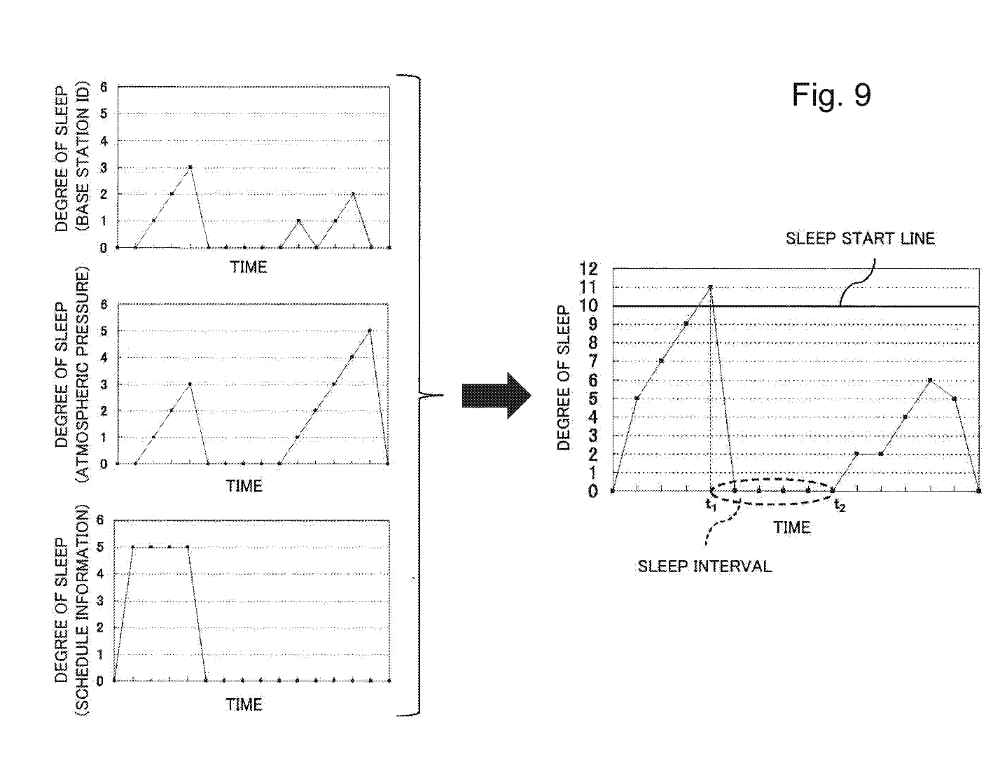

A concrete flow in which the setting unit 102 sets a control rule and the control unit 103, based on this control rule, controls the sleep state of the estimation unit 104 will be described with reference to FIG. 9. FIG. 9 is a diagram illustrating examples of transition of degrees of sleep. For convenience in description, it is assumed in FIG. 9 that the extraction unit 101 acquires the base station ID, the atmospheric pressure, and the schedule information as index data, and that the setting unit 102 adjusts only the sleep time according to the gradient of the degree of sleep. The three graphs illustrated on the left in FIG. 9 are graphs illustrating temporal changes in the degree of sleep of each of the base station ID, the atmospheric pressure, and the schedule information. Furthermore, the graph illustrated on the right in FIG. 9 is a graph illustrating temporal changes in the degree of sleep where the three graphs are integrated. In the graph on the right in FIG. 9, the degree of sleep exceeds the sleep starting line at time t1. At this time, the setting unit 102 sets the sleep time according to the gradient of the degree of sleep. In this example, the setting unit 102 determines the time from time t1 to time t2 as the sleep time. As stated above, the setting unit 102 adjusts the interval defined from time t1 to time t2 according to the gradient of the degree of sleep when the sleep starting line is exceeded. For example, in the case of a rise with the gradient of the degree of sleep being greater than or equal to a predetermined gradient, the setting unit 102 sets the interval defined from time t1 to time t2 longer than when the gradient of the degree of sleep is less than the predetermined gradient. On the other hand, in the case of a gentle rise with the gradient of the degree of sleep being less than or equal to a predetermined gradient, the setting unit 102 sets the interval defined from time t1 to time t2 shorter than when the gradient of the degree of sleep is greater than or equal to the predetermined gradient. Then, the control unit 103 causes the estimation unit 104 to sleep until the elapse of the sleep time indicated by the interval from time t1 to time t2 determined by the setting unit 102.

In FIG. 9, it is indicated that processing units, such as the extraction unit 101, are also caused to sleep while the estimation unit 104 is caused to sleep. However, it is also permissible to cause the processing units, such as the extraction unit 101, to continue operating, instead of causing those processing units to sleep, while the estimation unit 104 is caused to sleep. By doing so, it becomes possible to extend or shorten the sleep time of the estimation unit 104 based on changes in the degree of sleep acquired while the estimation unit 104 is caused to sleep, so that the sleep state can be more finely controlled.

### Operation and Effects of Second Exemplary Embodiment

As in the above, in the present exemplary embodiment, the change frequency information pieces extracted from a plurality of kinds of index data different in their indexes, such as the base station ID and the atmospheric pressure, are converted into degrees of sleep. Then, based on the change frequency information pieces converted into the degrees of sleep, the control rule for the sleep state of the estimation unit 104 is set. Due to this, according to the present exemplary embodiment, it becomes possible to judge various index data different in index as “degree of sleep” in a unified manner, so that the control rule for controlling the sleep state, such as the start timing of sleep or the sleep time, can be more finely set.

### Third Exemplary Embodiment

An information terminal 1 in the present exemplary embodiment learns change frequency information regarding specific index data from a history of index data acquired by the information terminal 1. Note that the specific index data pieces are index data pieces that can specify one piece of change frequency information by one index data piece without relying on the history, out of the index data pieces acquired by the information terminal 1. For example, the ID of a base station that statistically tends to continue to be connected for a long time longer than or equal to a predetermined threshold value (index data) is learned as specific index data, and information that indicates that the change frequency is small is learned as the change frequency information about the specific index data. Then, the information terminal 1 extracts the change frequency information regarding the specific index data that has been learned, as change frequency information about the acquired index data. Hereinafter, the information terminal 1 in the third exemplary embodiment will be described, centering on contents different from those of the first and second exemplary embodiments. In the description below, substantially the same contents as those of the first and second exemplary embodiments are omitted from the description as appropriate.

[Processing Configuration]

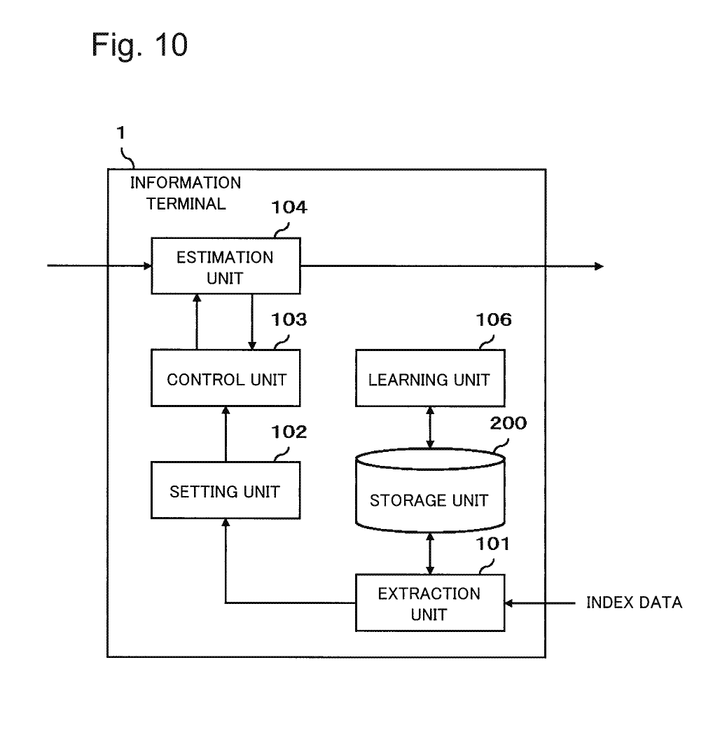

FIG. 10 is a diagram conceptually illustrating a processing configuration example of the information terminal 1 in the third exemplary embodiment. An illustrated in FIG. 10, the information terminal 1 in the present exemplary embodiment further has a learning unit 106 and a storage unit 200.

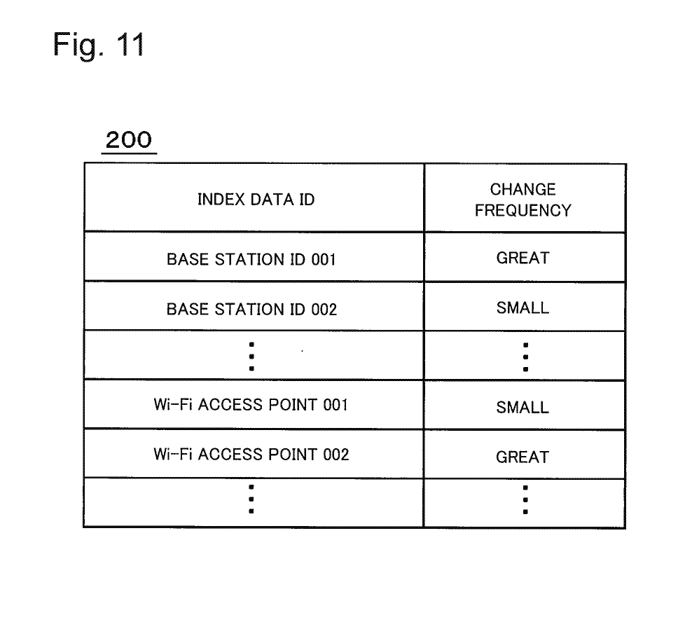

The learning unit 106 learns change frequency information pieces about various index data, based on the history of the index data acquired by the information terminal 1. The “history of index data” means, for example, index data acquired in a predetermined period (for example, one week, one month, or the like). The history of index data may be stored in a storage area of the information terminal 1 or may also be stored in a storage area of another apparatus located outside, such as a server. In the present exemplary embodiment, it is assumed that the history of index data acquired by the extraction unit 101 is stored in the storage unit 200 that the information terminal 1 has. The learning unit 106 is able to extract change frequency information that corresponds to specific index data from the history of index data stored in the storage unit 200 and acquired during a predetermined period. For example, by statistically analyzing the history of the base station ID or the Wi-Fi access point acquired during the predetermined period, a base station ID or a Wi-Fi access point that continues to be connected for a time longer than or equal to a predetermined threshold time (in other words, whose change frequency is small) and a base station ID or a Wi-Fi access point that, if connected, is switched shortly in a time less than a predetermined threshold value (in other words, whose change frequency is great) can both be recognized. Then, the learning unit 106 stores identifiers that indicate specific index data such as a base station ID or the SSID of a Wi-Fi access point and the change frequency information recognized from the histories of index data with each other into the storage unit 200 in association with each other. FIG. 11 is a diagram illustrating an example of correspondence relations between specific index data and change frequency information stored in the storage unit 200. In the example in FIG. 11, correspondence relations between index data IDs that are identifiers that identify the specific index data and the change frequency information pieces that correspond to the specific index data are stored. The extraction unit 101, using the acquired index data, refers to the storage unit 200 and extracts the change frequency information regarding the specific index data stored in the storage unit 200. Furthermore, the information that indicates the correspondence relations between the specific index data and change frequency information may be stored in a storage area of another apparatus located outside, such as a server. In that case, the extraction unit 101, using the acquired index data, refers to the storage area of another apparatus located outside, and extracts the change frequency information regarding the specific index data stored in the storage area.

### Operation Examples

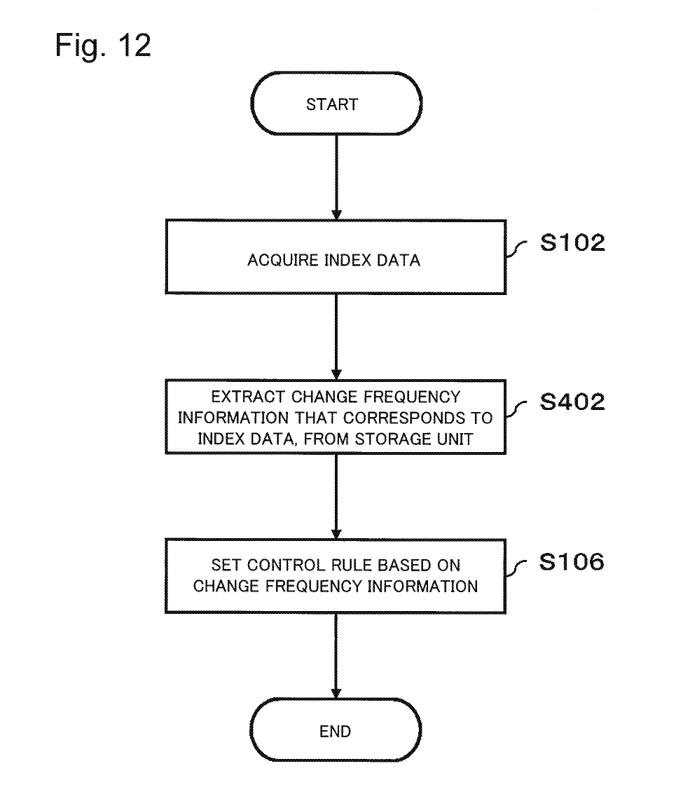

Hereinafter, a flow of processing by the information terminal 1 in the third exemplary embodiment will be described, using FIG. 12. FIG. 12 is a flowchart illustrating a flow of processing by the information terminal 1 in the third exemplary embodiment.

The information terminal 1, using the index data acquired in S102, refers to the storage unit 200 to extract change frequency information that corresponds to that index data (S402). For example, assumed that when the storage unit 200 stores information as illustrated in FIG. 11, index data indicating “base station ID 001” has been acquired in S102. In this case, the information terminal 1 extracts from the storage unit 200 information that has been associated with the “base station ID 001” and that indicates that the change frequency is great. Then, based on the change frequency information acquired in S402, the information terminal 1 sets the control rule (S106), as has been described in conjunction with the first exemplary embodiment.

### Operation and Effects of Third Exemplary Embodiment

As in above, in the present exemplary embodiment, change frequency information about specific index data recognized from the history of the index data acquired in the past is stored in the storage unit 200. Then, using the index data acquired by the extraction unit 101, the storage unit 200 is referred to, so that the change frequency information that corresponds to the index data is extracted. Due to this, according to the present exemplary embodiment, with regard to the specific index data, change frequency information can be acquired via one piece of data merely referring to the storage unit 200, instead of calculating change frequency information about that specific index data from history of a plurality of pieces of data. Hence, the amount of calculation in the information terminal 1 can be lessened, and therefore the electric power consumption of the information terminal 1 can be further reduced.

### Fourth Exemplary Embodiment

An information terminal 1 in the present exemplary embodiment controls the sleep state of the estimation unit 104 by using the change frequency information about index data extracted in an information terminal that another user uses. Hereinafter, the information terminal 1 in the fourth exemplary embodiment will be described, centering on contents different from those of the first to third exemplary embodiments. In the following description, substantially the same contents as those of the first to third exemplary embodiments are omitted from the description as appropriate.

[Processing Configuration]

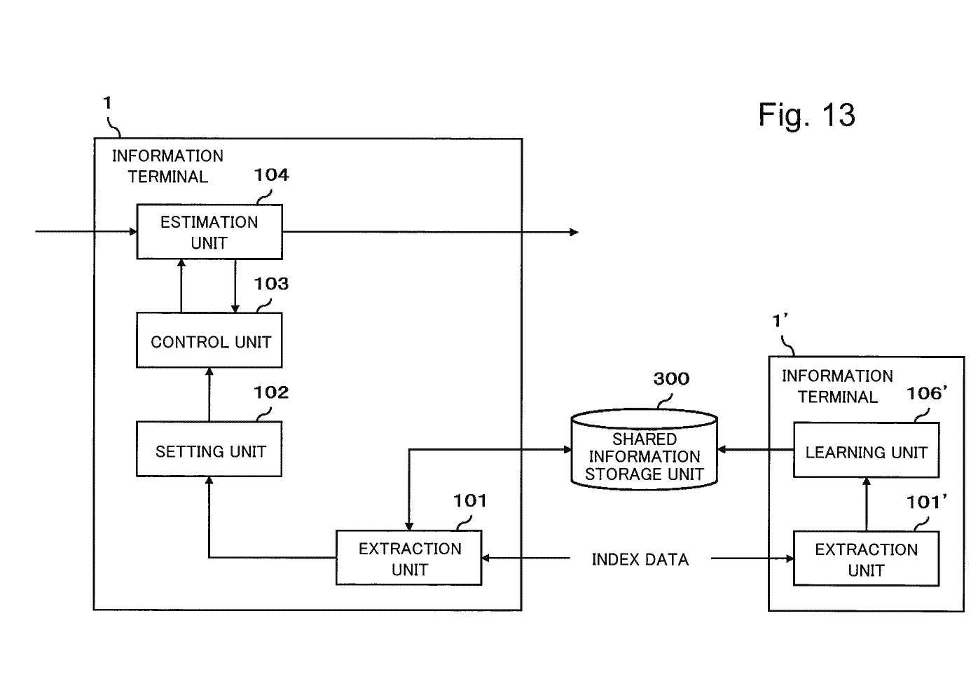

FIG. 13 is a diagram conceptually illustrating a processing configuration example of a movement estimation system in the fourth exemplary embodiment. The movement estimation system in the present exemplary embodiment is constructed of an information terminal 1 of a user, an information terminal 1′ of another user, and a shared information storage unit 300. A plurality of the other user terminal 1′ may exist.

The other user terminal 1′ has at least substantially the same configuration as the information terminal 1. In FIG. 13, only an extraction unit 101′ and a learning unit 106′, which are needed for the description, are illustrated. The extraction unit 101′ performs substantially the same processing as the extraction unit 101 of the foregoing exemplary embodiments. Furthermore, the learning unit 106′, like the learning unit 106 of the foregoing exemplary embodiment, learns change frequency information about various index data based on the acquired index data, and stores results of the learning into the shared information storage unit 300. The shared information storage unit 300 is provided in another apparatus located outside the information terminal 1, such as a server. The shared information storage unit 300, like the storage unit 200 of the third exemplary embodiment, stores correspondence relations between specific index data and change frequency information as illustrated in FIG. 11. When change frequency information that corresponds to specific index data is sent from a plurality of information terminals 1′ of other users, the shared information storage unit 300 stores a value obtained through comprehensive judgement from a plurality of change frequency information pieces by, for example, calculating an average value or an intermediate value of the change frequency information pieces, or the like.

### Operation Example

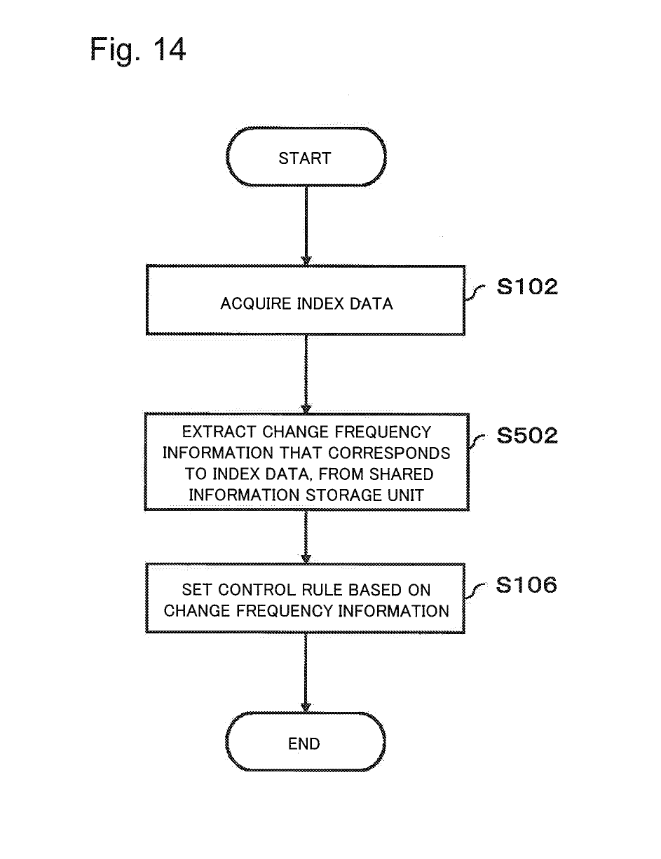

Hereinafter, a flow of processing by the information terminal 1 in the fourth exemplary embodiment will be described, using FIG. 14. FIG. 14 is a flowchart showing a flow of processing by the information terminal 1 in the fourth exemplary embodiment.

The information terminal 1, using the index data acquired in S102, refers to the shared information storage unit 300 so as to extract change frequency information that corresponds to that index data (S502). Then, based on the change frequency information acquired in S502, the information terminal 1 sets the control rule (S106) as described in conjunction with the first exemplary embodiment.

### Operation and Effects of Fourth Exemplary Embodiment

As in above, in the present exemplary embodiment, the change frequency information extracted by the information terminal 1′ of another user is extracted based on the index data acquired by the information terminal 1. Due to this, according to the present exemplary embodiment, the sleep state of the estimation unit 104 can be accurately controlled in accordance with the change frequency information about index data statistically recognized by the information terminal 1′ of the another user.

### Fifth Exemplary Embodiment

An information terminal 1 in the present exemplary embodiment, using the change frequency about index data, further improves the accuracy of the movement estimation processing of the estimation unit 104. Hereinafter, the information terminal 1 in the fifth exemplary embodiment will be described, centering on contents different from those of the first to fourth exemplary embodiments. In the following description, substantially the same contents as those of the first to fourth exemplary embodiments will be omitted from the description as appropriate.

[Processing Configuration]

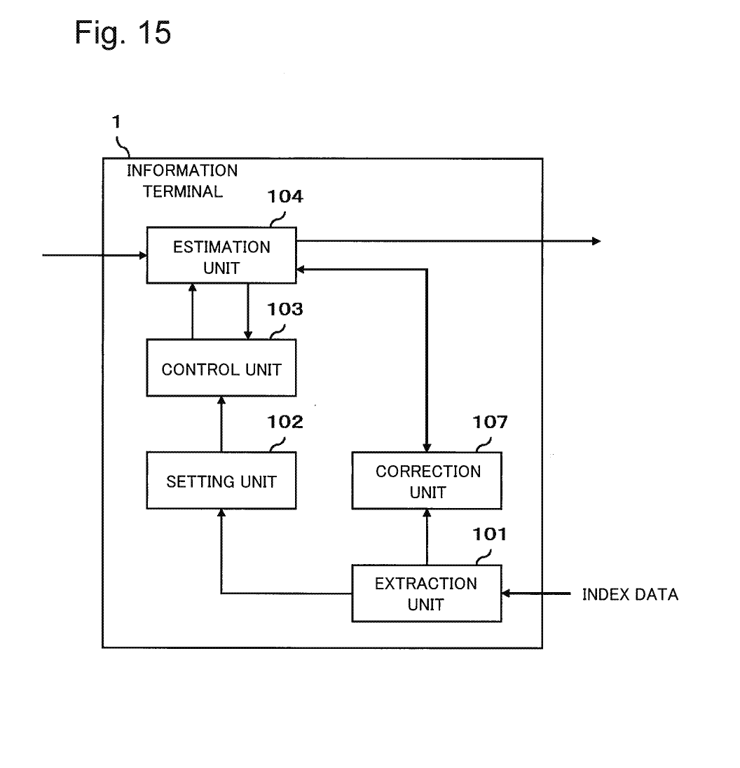

FIG. 15 is a diagram conceptually illustrating a processing configuration example of the information terminal 1 in the fifth exemplary embodiment. As illustrated in FIG. 15, the information terminal 1 in the present exemplary embodiment further has a correction unit 107.

The correction unit 107 corrects an estimation result from the estimation unit 104 based on the change frequency information extracted by the extraction unit 101. For example, when the same base station ID has been acquired continually, the estimation unit 104 assumes to have estimated that the user's movement state is the “motor vehicle” or the “electric train”. Note that if the user is actually moving using a motor vehicle or an electric train, the base station ID or the like must frequently change. Then, in the present situation where the same base station ID has been acquired continually, the possibility of the user riding in a motor vehicle or on an electric train is considered to be low. Specifically, it can be judged that the possibility that the estimation by the estimation unit 104 is an error is high. Therefore, the correction unit 107, considering the situation where the same base station ID has been continually acquired, corrects the estimation result from the estimation unit 104 to “stop” or the like.

### Operation Example

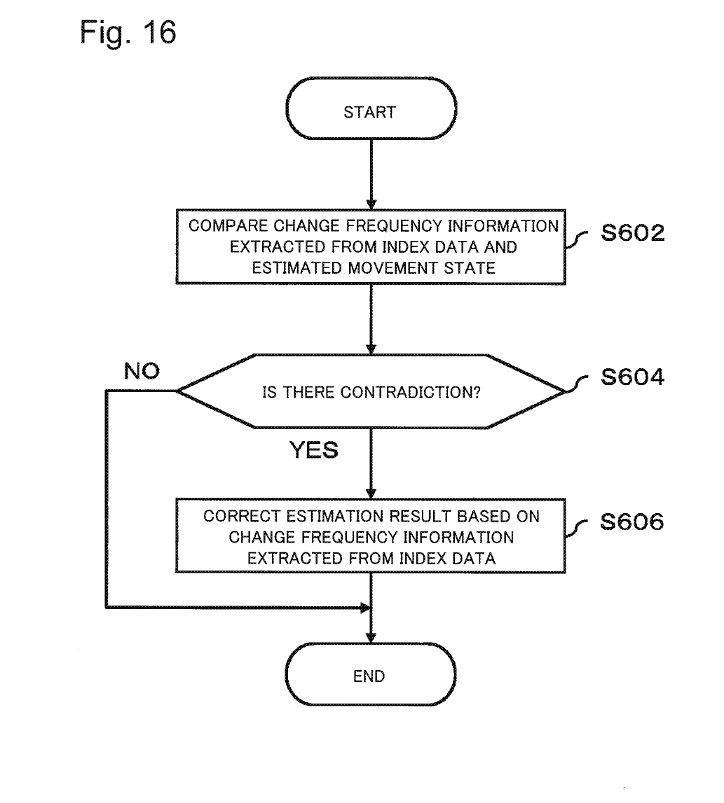

Hereinafter, a flow of processing by the information terminal 1 in the fifth exemplary embodiment will be described, using FIG. 16. FIG. 16 is a flowchart illustrating a flow in which the information terminal 1 in the fifth exemplary embodiment corrects an estimation result.

First, the information terminal 1 compares the change frequency information extracted from index data by the extraction unit 101 with the movement state estimated by the estimation unit 104 (S602). Then, the information terminal 1 determines whether or not the change frequency information extracted from index data and the movement state estimated by the estimation unit 104 contradict each other. Then, when it is determined that the change frequency information extracted from the index data and the movement state estimated by the estimation unit 104 contradict each other (S604: YES), the information terminal 1 corrects the movement state estimated by the estimation unit 104, based on the change frequency information extracted by the extraction unit 101. For example, when although the index data extracted by the extraction unit 101 has not changed, the movement state estimated by the estimation unit 104 is “motor vehicle” or “electric train”, the possibility that the estimation unit 104 has output a wrong estimation result for any cause is high. In this case, the information terminal 1 determines that the change frequency of the index data and the estimated movement state contradict each other. Then, the information terminal 1 corrects the movement state to “stop” or the like, based on the change frequency information of “having not changed” (S606). On the other hand, when it is determined that the change frequency information extracted from the index data and the movement state estimated by the estimation unit 104 do not contradict (S604: NO), the information terminal 1 does not correct the movement state estimated by the estimation unit 104.

### Operation and Effects of Fifth Exemplary Embodiment

As in above, in the present exemplary embodiment, it is judged whether or not the change frequency information extracted from index data by the extraction unit 101 and the movement state estimated by the estimation unit 104 contradict each other. Then, when a result that these two contradict is indicated, the movement state estimated by the estimation unit 104 is corrected, using the change frequency information extracted from the index data as a reference. Due to this, according to the present exemplary embodiment, it is possible to restrain error in the estimation by the estimation unit 104 and therefore improve the estimation accuracy for the user's movement state.

### Sixth Exemplary Embodiment

An information terminal 1 in the present exemplary embodiment adjusts at least the sleep time set in the control rule, using the movement tendency information extracted from history of a user's movement state estimated by the estimation unit 104. Note that the movement tendency information is information that indicates the tendency as to how long various movement states continue with regard to a certain user. Hereinafter, the information terminal 1 in the sixth exemplary embodiment will be described, centering on contents different from those of the first to fifth exemplary embodiments. In the following description, substantially the same contents as those of the first to fifth exemplary embodiments will be omitted from the description as appropriate.

[Processing Configuration]

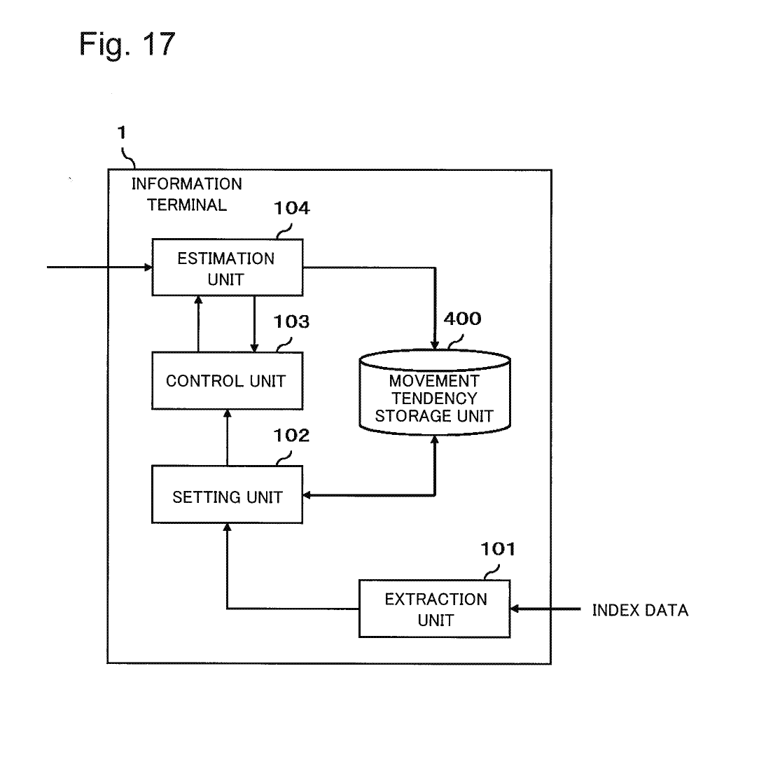

FIG. 17 is a diagram conceptually illustrating a processing configuration example of the information terminal 1 in the sixth exemplary embodiment. The information terminal 1 in the present exemplary embodiment extracts movement tendency information from history of the user's movement states estimated by the estimation unit 104 and stores the extracted information into a movement tendency storage unit 400. Then, based on the stored movement tendency information, the information terminal 1 adjusts the movement state continuation threshold time and the sleep time set in the control rule as illustrated in FIG. 3A and FIG. 3B.

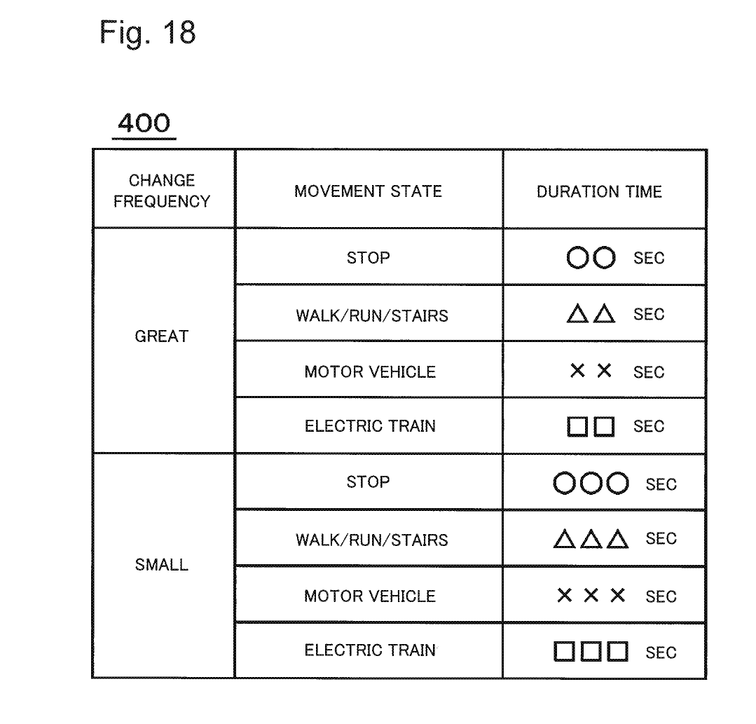

The information terminal 1 extracts movement tendency information from history of the user's movement states estimated by the estimation unit 104. The estimation unit 104, for example, calculates an average value or an intermediate value of the duration time of each movement state from the history of the user's movement states estimated by the estimation unit 104, and obtains movement tendency information in association with each movement state. At this time, the estimation unit 104 determines whether or not the change frequency of the present movement state of the user is great based on the control rule set in the information terminal 1. Then, the estimation unit 104 stores into the movement tendency storage unit 400 the extracted movement tendency information and the change frequency of the user's movement state in association with each other. FIG. 18 is a diagram illustrating an example of information that the movement tendency storage unit 400 stores. Note that the movement tendency information stored in the movement tendency storage unit 400 is updated every time information is received from the estimation unit 104. Then, the setting unit 102, using the change frequency information acquired by the extraction unit 101, acquires the movement tendency information from the movement tendency storage unit 400. Then, the setting unit 102 calculates the movement state continuation threshold time for each movement state and the corresponding sleep times from the acquired movement tendency information, and sets them in the control rule. Note that the setting unit 102 calculates the movement state continuation threshold time for each movement state and the corresponding sleep times by, for example, dividing the duration time of each movement state included in the movement tendency information by a predetermined proportion. This movement tendency storage unit 400 may be provided in another apparatus located outside, such as a server. In this case, the movement tendency storage unit 400 further has information for identifying users such as user IDs, and the information terminal 1, using its own user ID, acquires the movement tendency information that corresponds to the user of the information terminal 1 from the movement tendency storage unit 400.

### Operation Examples

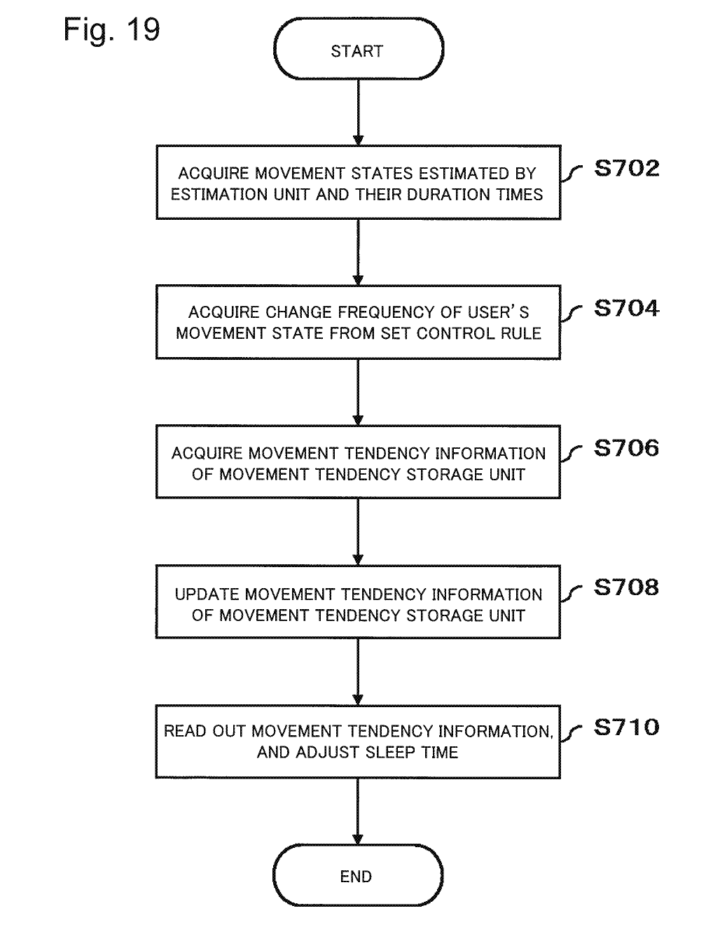

Hereinafter, a flow of processing by the information terminal 1 in the sixth exemplary embodiment will be described using FIG. 19. FIG. 19 is a flowchart illustrating a flow of processing by the information terminal 1 in the sixth exemplary embodiment.

The information terminal 1 acquires the user's movement states estimated by the estimation unit 104 and their duration times (S702). The information terminal 1 is able to calculate the duration time of a movement state by, for example, counting a time from when a movement state is estimated to when another movement state is estimated. Furthermore, the information terminal 1 checks the presently set control rule, and acquires the change frequency of the present movement state of the user (S704). Then, the information terminal 1 acquires, from the movement tendency storage unit 400, movement tendency information that corresponds to the movement state acquired in S702 and the change frequency of the user's movement state acquired in S704 (S706). Then, the information terminal 1 updates the movement tendency information of the movement tendency storage unit 400 by calculating an average value or an intermediate value of the duration time acquired in S702 and the duration time included in the movement tendency information acquired in S706 (S708). Then, the information terminal 1, using the change frequency information extracted by the extraction unit 101, reads out movement tendency information from the movement tendency storage unit 400. Then, the information terminal 1 adjusts the sleep time using as a basis the duration time of each movement state included in the read-out movement tendency information (S710). For example, the information terminal 1 calculates the movement state continuation threshold times of the movement states and their corresponding sleep times by, for example, diving the duration time of each movement state included in the movement tendency information by a predetermined proportion. Furthermore, the information terminal 1 may directly use the read-out duration time of each movement state, or may use the read-out duration time after correcting it using an arbitrary constant.

Furthermore, if a duration time of each movement state is calculated for every change pattern of the movement state and is used as movement tendency information, the present exemplary embodiment can be also applied to the sleep time setting tables illustrated in FIG. 6A and FIG. 6B.

### Operation and Effects of Sixth Exemplary Embodiment

As in above, in the present exemplary embodiment, the duration times of various movement states regarding a certain user are recognized based on history of the movement states estimated by the estimation unit 104. Then, based on the recognized duration time of each movement state, the sleep time of the estimation unit 104 is adjusted. Due to this, according to the present exemplary embodiment, it is possible to accurately control the sleep state of the estimation unit 104 by feeding back to the information terminal 1 the tendency about the duration times of movement states of users, or the like.

[Modifications]

Although the exemplary embodiments of the present invention have been described above with reference to the accompanying drawings, these are exemplifications of the present invention, and various configurations other than the foregoing can also be adopted.

For example, although the foregoing exemplary embodiments illustrate examples in which the operation settings for the sleep processing are divided for two stages that are when the change frequency of index data is great and when it is small, the change frequency of index data may be more finely classified using a plurality of threshold values and the operation settings for the sleep processing may be divided into three or more stages.

Furthermore, although in the plurality of flowcharts used in the foregoing descriptions, a plurality of steps (processing) are mentioned in order, the execution sequence of the steps executed in each exemplary embodiment is not restricted by the order in which the steps are mentioned. In 5 each exemplary embodiment, the order of steps depicted can be changed within such a range that there is no problem in terms of content. Furthermore, the foregoing exemplary embodiments can be combined within such a range that the contents do not contradict each other.

This application claims the priority based on Japanese Patent Application No. 2013-060455 filed on Mar. 22, 2013, the disclosure of which is incorporated herein in its entirety by reference.

What is claimed is:

1. An information terminal comprising:
an extraction unit that extracts at least one of change frequency of index data and the change frequency of a movement state of a user which are indicated by the acquired index data as change frequency information;
a setting unit that sets a rule for controlling a sleep state of an estimation unit that estimates the movement state of the user, based on the extracted change frequency information; and
a control unit that controls the sleep state of the estimation unit based on the set rule.

2. The information terminal according to claim 1, wherein:
the setting unit sets the rule that corresponds to the change frequency information extracted by the extraction unit and that indicates a correspondence relation, about each of movement states of the user estimatable by the estimation unit, between either one of a duration time of the movement state or number of times of continuation of the movement state and a sleep time; and
the control unit, based on at least either one of the duration time of the movement state of the user estimated by the estimation unit or the number of times of continuation of the movement state of the user estimated by the estimation unit, determines the sleep time from the rule, and causes the estimation unit to sleep for the determined sleep time.

3. The information terminal according to claim 1, wherein:
the setting unit sets the rule that corresponds to the change frequency information extracted by the extraction unit and that indicates a correspondence relation between a change pattern of the movement state of the user that is estimatable by the estimation unit and the sleep time; and
the control unit, based on the change pattern of the movement state of the user estimated by the estimation unit, determines the sleep time from the rule, and causes the estimation unit to sleep for the determined sleep time.

4. The information terminal according to claim 1, wherein
the setting unit acquires continuation tendency information about each movement state that is extracted from a history of the movement state of the user estimated by the estimation unit and adjusts at least sleep time in the rule using the acquired continuation tendency information.

5. The information terminal according to claim 1, further comprising
a conversion unit that converts a plurality of the change frequency information extracted respectively from a plurality of kinds of the index data into unified change frequency information, wherein
the setting unit sets the rule based on the unified change frequency information.

6. The information terminal according to claim 1, further comprising
a learning unit storing into a storage unit the change frequency information about specific index data that is extracted from a history of the index data acquired by the information terminal, wherein
the extraction unit uses the change frequency information about the specific index data specified based on the acquired index data as the change frequency information about the acquired index data.

7. The information terminal according to claim 1, wherein
the extraction unit acquires, from a storage unit that stores the change frequency information extracted by an information terminal of another user, the change frequency information extracted by the information terminal of the another user and specified based on the acquired index data, and uses the acquired change frequency information as a change frequency of the acquired index data.

8. The information terminal according to claim 1, further comprising
a correction unit that, based on a result of comparison between the movement state of the user estimated by the estimation unit and the change frequency information about the acquired index data, corrects the estimated movement state of the user.

9. The information terminal according to claim 1, wherein
the extraction unit acquires as the index data at least one of a base station ID of a communication base station, an SSID (Service Set Identifier) of a Wi-Fi (Wireless Fidelity) access point, atmospheric pressure, or schedule information in which a schedule of the user is stored.

10. A movement estimation method executed by a computer, the movement estimation method comprising:
extracting at least one of change frequency of index data and the change frequency of a movement state of a user which are indicated by the acquired index data as change frequency information;
setting a rule for controlling a sleep state of an estimation unit that estimates the movement state of the user, based on the extracted change frequency information; and
controlling the sleep state of the estimation unit based on the set rule.

11. The movement estimation method according to claim 10, wherein
the computer
sets the rule that corresponds to the change frequency information extracted and that indicates a correspondence relation, about each of movement states of the user estimatable by the estimation unit, between either one of a duration time of the movement state or number of times of continuation of the movement state and a sleep time, and,
based on at least either one of the duration time of the movement state of the user estimated by the estimation unit or the number of times of continuation of the movement state of the user estimated by the estimation unit, determines the sleep time from the rule, and causes the estimation unit to sleep for the determined sleep time.

12. The movement estimation method according to claim 10, wherein
the computer
sets the rule that corresponds to the change frequency information extracted and that indicates a correspondence relation between a change pattern of the movement state of the user that is estimatable by the estimation unit and the sleep time, and,
based on the change pattern of the movement state of the user estimated by the estimation unit, determines the sleep time from the rule, and causes the estimation unit to sleep for the determined sleep time.

13. The movement estimation method according to claim 10, wherein
the computer
acquires continuation tendency information about each movement state that is extracted from a history of the movement state of the user estimated by the estimation unit and adjusts at least sleep time in the rule using the acquired continuation tendency information.

14. The movement estimation method according to claim 10, wherein
the computer
converts a plurality of the change frequency information extracted respectively from a plurality of kinds of the index data into unified change frequency information, and
sets the rule based on the unified change frequency information.

15. The movement estimation method according to claim 10, wherein
the computer
stores into a storage unit the change frequency information about specific index data that is extracted from a history of the index data acquired by the computer, and
uses the change frequency information about the specific index data specified based on the acquired index data as the change frequency information about the acquired index data.

16. The movement estimation method according to claim 10, wherein
the computer
acquires, from a storage unit that stores the change frequency information extracted by a computer of another user, the change frequency information extracted by an information terminal of the another user and specified based on the acquired index data, and uses the acquired change frequency information as a change frequency of the acquired index data.

17. The movement estimation method according to claim 10, wherein
the computer,
based on a result of comparison between the movement state of the user estimated by the estimation unit and the change frequency information about the acquired index data, corrects the estimated movement state of the user.

18. The movement estimation method according to claim 10, wherein
the computer
acquires as the index data at least one of a base station ID of a communication base station, an SSID (Service Set Identifier) of a Wi-Fi (Wireless Fidelity) access point, atmospheric pressure, or schedule information in which a schedule of the user is stored.

19. A non-transitory computer readable storage medium storing a program that causes a computer to realize:
an extraction unit that extracts at least one of change frequency of index data and the change frequency of a movement state of a user which are indicated by the acquired index data as change frequency information;
a setting unit that sets a rule for controlling a sleep state of an estimation unit that estimates the movement state of the user, based on the extracted change frequency information; and
a control unit that controls the sleep state of the estimation unit based on the set rule.
